(19) United States
(12) Patent Application Publication
(10) Pub. No.: US 2023/0227658 A1
(43) Pub. Date: Jul. 20, 2023

(54) COMPOSITE PARTICLE PRODUCTION METHOD, COMPOSITE PARTICLE AND MIXTURE

(71) Applicant: DENKA COMPANY LIMITED, Tokyo (JP)

(72) Inventors: Naotsugu NOGAMI, Tokyo (JP); Motoharu FUKAZAWA, Tokyo (JP); Takuto OKABE, Tokyo (JP)

(73) Assignee: DENKA COMPANY LIMITED, Tokyo (JP)

(21) Appl. No.: 17/928,900

(22) PCT Filed: May 10, 2021
(86) PCT No.: PCT/JP2021/017720

§ 371 Date: Nov. 30, 2022

(30) Foreign Application Priority Data
Jun. 9, 2020 (JP) 2020-100282

(51) Int. Cl. C09C 3/06; C09C 1/00; C03C 14/00; C08K 9/02

(52) U.S. Cl. CPC C09C 3/063; C09C 1/0081; C03C 14/004; C08K 9/02; C01P 2004/84; C01P 2002/72; C01P 2004/03; C03C 2214/05

(57) ABSTRACT

A method for producing a composite particle, the method containing: (a) mixing a raw material particle and at least one type of fine particles selected from SiO₂ fine particles and Al₂O₃ fine particles, the fine paricles having a diameter smaller than that of the raw material particle; and (b) heating the mixture of the raw material particles and the fine particles, wherein the raw material particle contains three components of ZnO, Al₂O₃, and SiO₂, and a content of the ZnO is 17 to 43% by mole, a content of the Al₂O₃ is 9 to 20% by mole, and a content of the SiO₂ is 48 to 63% by mole, based on the total content of the three components.

### TECHNICAL FIELD

The present invention relates to a method for a composite particle, a composite particle and a mixture.

### BACKGROUND ART

In general, various powdery fillers are used for the purpose of improving the physical properties or functions of base materials such as glass materials and resin materials. For example, amorphous silica is used as a filler for controlling the thermal expansion coefficient of a base material since it has a small thermal expansion coefficient of about 0.5×10⁻⁶/° C. and is relatively easily available. However, when the filler is added to a base material used for bonding, sealing, molding, or the like, a filler having a thermal expansion coefficient smaller than that of amorphous silica is desired in order to match the thermal expansion coefficient of the filler with that of the base material and suppress the occurrence of thermal stress.

Many materials such as zirconium phosphate, zirconium tungstate and manganese nitride are known as materials having a smaller thermal expansion coefficient than amorphous silica. However, since the specific gravity of these materials is large and the weight of the resin material and the like after blending becomes heavy, it is not general to use them for electronic parts and the like. In order to compensate for this drawback, Patent Document 1 discloses SiO₂-TiO₂ glass, Li₂O-Al₂O₃-SiO₂-based crystallized glass, and ZnO-Al₂O₃-SiO₂-based crystallized glass, as lightweight materials having a small thermal expansion coefficient. Patent Document 2 discloses an inorganic powder having one or more crystalline phases selected from β-eucryptite, β-eucryptite solid solution, β-quartz, and β-quartz solid solution. Non-Patent Document 1 discloses Zn_{0.5}AlSi₂O₆, LiAlSi₂O₆, and LiAlSiO₄.

### CITATION LIST

### Patent Document

[Patent Document 1] Japanese Patent Laid-Open No. 2-208256

[Patent Document 2] Japanese Patent Laid-Open No. 2007-91577

### Non-patent Document

[Non-patent Document 1] Journal of Materials Science 26 p.3051 (1991)

### SUMMARY OF INVENTION

### Technical Problem

When the filler as described above is blended into a base material such as a resin material, the fluidity and moldability of the base material can be enhanced by lowering the viscosity of the base material after blending. In addition, by keeping the viscosity after blending low, the filling rate of the filler can be increased, and the thermal expansion coefficient can be further reduced. However, in conventional fillers, there is still room for improvement in lowering the viscosity of the base material after blending.

An object of one aspect of the present invention is to provide a composite particle containing three components of ZnO, Al₂O₃, and SiO₂ and capable of reducing the viscosity of a base material when the particle is blended into the base material, and a method for producing the composite particle.

### Solution to Problem

The present invention provides a method for producing a composite particle, a composite particle, and a mixture described below.

(1) A method for producing a composite particle, the method containing: (a) mixing a raw material particle and at least one type of fine particles selected from SiO₂ fine particles and Al₂O₃ fine particles, the fine paricles having a diameter smaller than that of the raw material particle; and (b) heating the mixture of the raw material particles and the fine particles, wherein the raw material particle comprises three components of ZnO, Al₂O₃, and SiO₂, and a content of the ZnO is 17 to 43% by mole, a content of the Al₂O₃ is 9 to 20% by mole, and a content of the SiO₂ is 48 to 63% by mole, based on the total content of the three components.
(2) The method according to (1), wherein the fine particles are added in an amount of 4 parts by mass or less based on 100 parts by mass of the raw material particle in the (a).
(3) A composite particle comprising: a core particle comprising three components of ZnO, Al₂O₃, and SiO₂; and at least one type of fine particles selected from SiO₂ fine particles and Al₂O₃ fine particles, the fine particles having a diameter smaller than that of the core particle and being fused to the surfaces of the core particle, wherein a content of the ZnO is 17 to 43% by mole, a content of the Al₂O₃ is 9 to 20% by mole, and a content of the SiO₂ is 48 to 63% by mole, based on the total content of the three components, in the core particle.
(4) The composite particle according to (3), wherein the composite particle has an average circularity is 0.60 or more.
(5) The composite particle according to (3) or (4), wherein the composite particle comprises 50 mass % or more of a β-quartz solid solution as a crystal phase based on the total amount of the composite particle.
(6) The composite particle according to any one of (3) to (5), wherein a content of each of Li, Na, and K is less than 100 ppm by mass based on the total amount of the composite particle.
(7) The composite particle according to any one of (3) to (6), wherein the composite particle is used by being blended in a glass or a resin.
(8) A mixture comprising: a first particle that is the composite particle according to any one of (3) to (7); and a second particle different from the first particle.
(9) The mixture according to (8), wherein the second particle has an average circularity of 0.80 or more.
(10) The mixture according to (8) or (9), wherein a content of the first particle is 10 vol % or more based on the total amount of the mixture.
(11) The mixture according to any one of (8) to (10), wherein the second particle is an SiO₂ particle or an Al₂O₃ particle.
(12) The mixture according to any one of (8) to (11), wherein the mixture is used by being blended in a glass or a resin.

### Advantageous Effects of Invention

According to one aspect of the present invention, it is possible to provide a composite particle containing three components of ZnO, Al₂O₃, and SiO₂ and capable of reducing the viscosity of a base material when the particle is blended into the base material, and a method for producing the composite particle.

### BRIEF DESCRIPTION OF DRAWINGS

FIG. 1 is an X-ray diffraction pattern of composite particles (particles) according to Examples and Comparative Examples.

FIG. 2 is an observation result by SEM of composite particles (particles) according to Comparative Example 1 and Example 1.

FIG. 3 is an observation result by SEM of composite particles according to Example 3 and Example 6.

FIG. 4 is an observation result by SEM of composite particles according to Example 8.

### DESCRIPTION OF EMBODIMENTS

Hereinafter, embodiments of the present invention will be described. However, the present invention is not limited to the following embodiments.

A method for producing a composite particle according to one embodiement contains: a step (a) mixing a raw material particle and at least one type of fine particles selected from SiO₂ fine particles and Al₂O₃ fine particles, the fine paricles having a diameter smaller than that of the raw material particle; and a step (b) heating the mixture of the raw material particles and the fine particles, wherein the raw material particle comprises three components of ZnO, Al₂O₃, and SiO₂, and a content of the ZnO is 17 to 43% by mole, a content of the Al₂O₃ is 9 to 20% by mole, and a content of the SiO₂ is 48 to 63% by mole, based on the total content of the three components. By this production method, it is possible to produce a composite particle containing a core particle containing three components of ZnO, Al₂O₃, and SiO₂, and at least one type of fine particles selected from SiO₂ fine particles and Al₂O₃ fine particles which are fused to the surface of the core particle (details will be described later).

In the step (a), a raw material particle is first prepared. The raw material particle contains three components: ZnO, Al₂O₃ and SiO₂. The step (a) may, in one embodiment, contain a step of producing a raw material particle (raw material particle preparation step). Alternatively, a raw material particle having an aspect described below may be purchased and prepared.

In the raw material particle preparation step, first, raw materials are mixed to prepare a raw material mixture. The raw materials may be zinc oxide or the like as a Zn source, aluminum oxide, aluminum hydroxide or the like as an Al source, and silicon oxide (α-quartz, cristobalite, amorphous silica or the like) as a Si source.

Regarding the blending amounts of the raw materials, based on the total amount of the raw materials of the Zn source, the Al source, and the Si source, the blending amount of the Zn source may be 17 to 43% by mole, the blending amount of the Al source may be 9 to 20% by mole, and the blending amount of the Si source may be 48 to 63% by mole.

In the raw material particle preparation step, a general nucleating agent such as zirconium oxide or titanium oxide may be added in addition to the raw materials described above within a range that does not affect the thermal expansion coefficient.

In the raw material mixture, the content of ionic impurities is preferably as small as possible. The content of the alkali metal contained in the raw material mixture is preferably 500 ppm by mass or less, more preferably 150 ppm by mass or less, still more preferably 100 ppm by mass or less, and particularly preferably 50 ppm by mass or less, based on the total amount of the raw material mixture, from the viewpoint of improving moisture resistance reliability and suppressing failure of electronic devices.

The mixing method of the raw material mixture is not particularly limited as long as it is a method in which an alkali metal such as Na, Li, or K and a metal element such as Fe are less likely to be mixed. For example, the raw material mixture may be mixed by a pulverizer such as an agate mortar, a ball mill, or a vibration mill, or various mixers.

In the raw material particle preparation step, next, the raw material mixture is put into a container such as a platinum crucible or an alumina crucible, and melted in a heating furnace such as an electric furnace, a high-frequency furnace, or an image furnace, or a flame burner. These melts are then removed in air or water and quenched. Thus, the raw material glass is obtained. The raw material particles are obtained by pulverizing the obtained raw material glass. The grinding method of the raw material glass is not particularly limited, and may be a method using an agate mortar, a ball mill, a vibration mill, a jet mill, a wet jet mill, or the like. The grinding may be performed in a dry manner, or may be performed in a wet manner by mixing raw material particles with a liquid such as water or alcohol.

When the raw material particle has the above-described composition, the thermal expansion coefficient of the base material blended with the composite particles to be produced can be reduced. In addition, during the production of the particles, the raw material can be easily melted, and crystallization can also be facilitated. In particular, it is possible to further reduce the thermal expansion coefficient of the base material in which the composite particle is blended by the composite particle having a composition in which the content of ZnO is 25 to 35% by mole, the content of Al₂O₃ is 11 to 18% by mole, and the content of SiO₂ is 50 to 55% by mole, based on the total content of the three components.

The step (a) may contain a step of spheroidizing the raw material particles (spheroidizing step). In the spheroidizing step, raw material particles are spheroidized by a so-called powder melting method. The spheroidizing method by the powder melting method is a method in which raw material particles are put into a chemical flame, a thermal plasma, a vertical tubular furnace, or a tower kiln, melted, and spheroidized by its own surface tension.

In the powder melting method, the particle size distribution after spheroidization can be adjusted by adjusting particles obtained by pulverizing raw material glass or raw material particles obtained by granulating raw material glass with a spray dryer or the like to have a desired particle size distribution. The raw material particles are put into a chemical flame or thermal plasma, a vertical tubular furnace, a tower kiln, or the like while suppressing aggregation of the raw material particles, and are melted to be spheroidized. Alternatively, spheroidization may be performed by preparing a dispersion liquid of raw material particles dispersed in a solvent or the like, spraying the liquid raw material into a chemical flame or thermal plasma, a vertical tubular furnace, a tower kiln, or the like using a nozzle or the like, evaporating the dispersion medium, and then melting the raw material particles.

In the powder melting method, the chemical flame refers to a flame generated by burning a combustible gas with a burner. As the combustible gas, any gas may be used as long as a temperature equal to or higher than the melting point of raw material particles can be obtained, and for example, natural gas, propane gas, acetylene gas, liquefied petroleum gas (LPG), hydrogen, or the like can be used. Air, oxygen or the like as the combustion supporting gas may be used in combination with the combustible gas. Conditions such as the size and temperature of the chemical flame can be adjusted by the size of the burner and the flow rates of the combustible gas and the combustion-supporting gas.

In the raw material particle, the content of ZnO is 17 to 43% by mole, the content of Al₂O₃ is 9 to 20% by mole, and the content of SiO₂ is 48 to 63% by mole, based on the total content of the three components of ZnO, Al₂O₃, and SiO₂.

The content of ZnO is 17 to 43% by mole based on the total content of the three components, and is preferably 20 to 40% by mole, more preferably 22 to 39% by mole, and still more preferably 25 to 35% by mole, from the viewpoint of reducing the thermal expansion coefficient of the base material. The content of ZnO may be 17 to 40% by mole, 17 to 39% by mole, 17 to 35% by mole, 20 to 43% by mole, 20 to 39% by mole, 20 to 35% by mole, 22 to 43% by mole, 22 to 40% by mole, 22 to 35% by mole, 25 to 43% by mole, 25 to 40% by mole, or 25 to 39% by mole, based on the total content of the three components.

The content of Al₂O₃ is 9 to 20% by mole, preferably 10 to 19% by mole, and more preferably 11 to 18% by mole, based on the total content of the three components. The content of Al₂O₃ may be 9 to 19% by mole, 9 to 18% by mole, 10 to 20% by mole, 10 to 18% by mole, 11 to 20% by mole, or 11 to 19% by mole, based on the total content of the three components.

The content of SiO₂ is 48 to 63% by mole, preferably 49 to 62% by mole, more preferably 50 to 62% by mole, and still more preferably 50 to 55% by mole, based on the total content of the three components. The content of SiO₂ may be 48 to 62% by mole, 48 to 55% by mole, 49 to 63% by mole, 49 to 55% by mole, or 50 to 63% by mole, based on the total content of the three components.

The diameter of the raw material particle is preferably 0.1 μm or more, more preferably 0.3 μm or more, and even more preferably 0.5 μm or more, and is preferably 75 μm or less, more preferably 35 μm or less, and even more preferably 10 μm or less. In the present specification, the diameter of the raw material particle refers to the median diameter (D50) of raw material particles. The median diameter of raw material particles mean 50% diameter (D50% diameter) in volume-based integrated fractions specified in JIS R 1629. In addition, the dispersion treatment before the measurement of the median diameter of the raw material particles and the addition of the dispersion liquid to the measurement apparatus are performed by the same method as described in “Median diameter of composite particles” in Examples.

Subsequently, the raw material particles (containing spheroidized raw material particles) described above are mixed with at least one type of fine particles selected from SiO₂ fine particles and Al₂O₃ fine particles, which have a diameter smaller than that of the raw material particle. Here, “diameter smaller than that of the raw material particle” means that the specific surface area diameter of the fine particles is smaller than the median diameter (D50) of the raw material particles measured by the above-described method. The specific surface area diameter of the fine particles is measured by the method described later.

The diameter of the fine particles is preferably 1/10 or less, more preferably 1/50 or less, and still more preferably 1/100 or less of the diameter (median diameter) of the raw material particles. The diameter of the fine particles may be, for example, 1 μm or less, 0.5 μm or less, or 0.1 μm or less, and may be 0.001 μm or more, 0.005 μm or more, or 0.01 μm or more. In the present specification, the diameter of fine particles means the specific surface area diameter of fine particles.

The specific surface area diameter d (m) in the present specification means a value obtained from d=6/(ρ×s), wherein ρ (g/cm³=100000×g/m³) is the true density of the fine particles, and s (m²/g) is the specific surface area of the fine particles. The specific surface area of the fine particles can be measured by a BET one point method using a specific surface area measuring device (for example, “Macsorb HM model-1201 fully automatic specific surface area measuring device” manufactured by Mountech Co., Ltd.). At this time, degassing conditions at the time of measurement may be 200° C. for 10 minutes, and an adsorption gas may be nitrogen. The true density of the fine particles can be measured by a gas (helium) replacement method using a dry densitometer (for example, “AccuPyc II1340” manufactured by Shimadzu Corporation).

The addition amount of the fine particles is preferably 4 parts by mass or less with respect to 100 parts by mass of the raw material particles. When a large amount of the fine particles is not added, the composite particles are suitably crystallized, and the fine particles themselves are less likely to remain in the powder containing the composite particles, and aggregation of the fine particles can be suppressed. As a result, it is possible to more effectively suppress an increase in viscosity when blended in the base material. The addition amount of the fine particles is more preferably 3 parts by mass or less, even more preferably 2 parts by mass or less, and particularly preferably 1 part by mass or less, and is preferably 0.1 parts by mass or more, and more preferably 0.2 parts by mass or more, with respect to 100 parts by mass of the raw material particles.

In the step (b), the mixture of the raw material particles and the fine particles is heated to crystallize the raw material particles. Furthermore, by this heating, the fine particles are fused to the surfaces of the raw material particles (core particles) after crystallization, and composite particles can be obtained.

When the fine particles are not used and only the raw material particles are used, the raw material particles after crystallization may aggregate due to heating of the raw material particles. However, when the aggregates are forcibly disintegrated, broken particles are easily formed, and it is difficult to effectively reduce the viscosity at the time of blending the base material. On the other hand, in the production method of the present embodiment, since the composite particles in which the fine particles are fused to the surface of the core particle can be obtained, aggregation of the composite particles can be suppressed, and as a result, an increase in viscosity at the time of blending the base material can be more effectively suppressed.

As a heating device for crystallization, any heating device may be used as long as a desired heating temperature can be obtained, and for example, an electric furnace, a rotary kiln, a pusher furnace, a roller hearth kiln, or the like can be used.

The heating temperature (crystallization temperature) is preferably from 750 to 900° C. When the heating temperature is in this range, the raw material particles can be crystallized while suppressing fusion of the raw material particles. In addition, it is possible to suppress generation of a silica-rich crystal phase or an alumina-rich crystal phase derived from the fine particles as much as possible. Accordingly, the content of the β-quartz solid solution as the crystal phase can be increased as much as possible, and the thermal expansion coefficient of the composite particle can be easily reduced. That is, when the heating temperature is in this range, the viscosity and the coefficient of thermal expansion of the base material in which the composite particle is blended can be easily reduced.

The heating time (crystallization time) is preferably 1 to 24 hours. When the heating time is 1 hour or more, crystallization into the β-quartz solid solution phase is sufficiently performed, and the thermal expansion coefficient of the base material in which the composite particles are blended can be further reduced. When the heating time is 24 hours or less, the cost can be suppressed.

The step (b) may contain, as necessary, a step of crushing the powder composed of composite particles by a method using an agate mortar, a ball mill, a vibration mill, a jet mill, a wet jet mill, or the like. The crushing may be performed in a dry manner, or may be performed in a wet manner by mixing with a liquid such as water or alcohol. In the wet crushing, the composite particles of the present embodiment are obtained by drying after crushing. The drying method is not particularly limited, and may be heat drying, vacuum drying, freeze drying, supercritical carbon dioxide drying, or the like.

In another embodiment, the method for producing the composite particle may further contain a step of classifying the composite particles so as to obtain a desired diameter (median diameter) and a surface treatment step using a coupling agent. By performing the surface treatment, the blending amount (filling amount) into the base material can be further increased. The coupling agent used for the surface treatment is preferably a silane coupling agent. The coupling agent may be a titanate coupling agent, an aluminate coupling agent, or the like.

The composite particle in which fine particles are fused to the surface of the raw material particle after crystallization can be obtained through the step (b). That is, the composite particle obtained by the above-described method contains a core particle (crystallized raw material particle) containing three components of ZnO, Al₂O₃, and SiO₂, and at least one type of fine particles selected from SiO₂ fine particles and Al₂O₃ fine particles, which have a diameter smaller than that of the core particle and are fused to the surface of the core particle.

Here, “diameter smaller than that of the core particle” means that the diameter of the fine particles measured by electron microscope observation is smaller than the diameter of the core particle measured by electron microscope observation. The composite particle according to the present embodiment is produced by the production method described above, and the specific surface area diameter of the fine particles is smaller than the median diameter of the raw material particles. Therefore, even in the composite particle, the diameter of the fine particles measured by electron microscope observation is smaller than the diameter of the core particle.

In the composite particle, the fine particles are firmly fused to the surface of the core particle by the heating in the step (b). This is completely different from the particle in the mixture obtained by simply mixing the core particles and the fine particles. The fusion of the fine particles to the core particles can be confirmed by subjecting the composite particles to ultrasonic treatment for 3 minutes using an ultrasonic bath or an ultrasonic homogenizer containing a solvent such as alcohol or acetone, dropping one to several drops of the dispersion onto a sample stage of an electron microscope, drying the dispersion, and observing the composite particles with a scanning electron microscope (SEM) to observe that a plurality of the fine particles adhere to the surface of the core particle. In the case of a simple mixture of the core particles and the fine particles, even if the fine particles are attached to the surface of the core particles, the fine particles are detached from the surface of the core particles by ultrasonic treatment.

In the composite particle, the fine particles are fused to the surface of the core particle as described above, and thus aggregation of the composite particles is suppressed. Therefore, it is possible to suppress an increase in viscosity when the composite particles are blended as a filler into a base material such as a resin. When the increase in viscosity of the base material can be suppressed, more composite particles can be blended into the base material, and thus the effect of suppressing thermal expansion can be improved.

In the core particle, the content of ZnO is 17 to 43% by mole, the content of Al₂O₃ is 9 to 20% by mole, and the content of SiO₂ is 48 to 63% by mole, based on the total content of the three components of ZnO, Al₂O₃, and SiO₂.

The content of ZnO is 17 to 43% by mole based on the total content of the three components, and is preferably 20 to 40% by mole, more preferably 22 to 39% by mole, and even more preferably 25 to 35% by mole, from the viewpoint of reducing the thermal expansion coefficient of the base material. The content of ZnO may be 17 to 40% by mole, 17 to 39% by mole, 17 to 35% by mole, 20 to 43% by mole, 20 to 39% by mole, 20 to 35% by mole, 22 to 43% by mole, 22 to 40% by mole, 22 to 35% by mole, 25 to 43% by mole, 25 to 40% by mole, or 25 to 39% by mole, based on the total content of the three components.

The content of Al₂O₃ is 9 to 20% by mole, preferably 10 to 19% by mole, and more preferably 11 to 18% by mole, based on the total content of the three components. The content of the Al₂O₃ may be 9 to 19% by mole, 9 to 18% by mole, 10 to 20% by mole, 10 to 18% by mole, 11 to 20% by mole, or 11 to 19% by mole, based on the total content of the three components.

The content of SiO₂ is 48 to 63% by mole, preferably 49 to 62% by mole, more preferably 50 to 62% by mole, and even more preferably 50 to 55% by mole, based on the total content of the three components. The content of the SiO₂ may be 48 to 62% by mole, 48 to 55% by mole, 49 to 63% by mole, 49 to 55% by mole, or 50 to 63% by mole, based on the total content of the three components.

The composite particle may contain ionic impurities, which are inevitable impurities, but the content thereof is preferably as small as possible from the viewpoint of improving moisture resistance reliability and suppressing failure of electronic devices. Examples of the ionic impurities include alkali metals such as Li, Na, and K. In the composite particle of the present embodiment, the total content of Li, Na, and K is preferably less than 500 ppm by mass, more preferably less than 300 ppm by mass, and still more preferably less than 200 ppm by mass, based on the total amount of the composite particle.

The content of Li is preferably less than 100 ppm by mass, more preferably less than 50 ppm by mass, and still more preferably less than 20 ppm by mass, based on the total amount of the composite particle. The content of Na is preferably less than 100 ppm by mass, more preferably less than 90 ppm by mass, and still more preferably less than 80 ppm by mass, based on the total amount of the composite particle. The content of K is preferably less than 100 ppm by mass, more preferably less than 70 ppm by mass, and still more preferably less than 40 ppm by mass, based on the total amount of the composite particle.

The composite particle may further contain zirconium oxide, titanium oxide, or the like as long as the thermal expansion coefficient is not affected. From the viewpoint of further improving the effect of reducing the thermal expansion coefficient of the base material, the content of the above-described three components is preferably 95% by mole or more, more preferably 98% by mole or more, and still more preferably 99% by mole or more, based on the total amount of the composite particle. From the same viewpoint, in one embodiment, the composite particle may consist of the above-described three components and inevitable impurities, or may consist of the above-described three components.

The composite particle of the present embodiment preferably contains a β-quartz solid solution as a crystalline phase. The composite particle may contain β-quartz solid solution as the main crystal. The content of the β-quartz solid solution is preferably 50% by mass or more, more preferably 60% by mass or more, still more preferably 70% by mass or more, and may be 72% by mass or more, or 75% by mass or more, based on the total amount of the composite particle. The content of the β-quartz solid solution is preferably as large as possible. When the content of the β-quartz solid solution is within the above range, the thermal expansion coefficient of the composite particle itself is reduced, and thus the thermal expansion coefficient of the base material can be further reduced. In particular, when the content of the β-quartz solid solution is 70% by mass or more, the thermal expansion of the base material is more effectively reduced by the composite particle. Further, since the blending amount (filling amount) of the composite particle in the base material can be further increased, the thermal expansion coefficient of the base material can be easily controlled. The structure of the β-quartz solid solution of the composite particle in the present embodiment can be expressed as xZnO-yAl₂O₃-zSiO₂. Identification of the crystalline phase and measurement of the content thereof can be performed by composite particle X-ray diffraction measurement/Rietveld method.

The composite particle may further contain an amorphous phase in addition to the β-quartz solid solution phase, or may further contain another crystalline phase. The composite particle may contain a willemite phase (Zn₂SiO₄) as another crystalline phase. If the composite particle contains, among other crystalline phases, a gahnite phase (ZnAl₂O₄), a mullite phase (Al₆Si₂O₁₃) and a cristobalite phase (SiO₂), the thermal expansion coefficient is relatively high. Therefore, the composite particle preferably does not contain these crystalline phases.

The shape of the composite particle is preferably as close to a spherical shape as possible. Whether or not the composite particle is substantially spherical can be confirmed by calculating the average circularity of the composite particle. The average circularity in the present specification is determined as follows. That is, a projected area (S) and a projected peripheral length (L) of composite particles photographed using an electron microscope are obtained, and the circularity is calculated by applying them to the following formula (1). The average circularity is an average value of the circularities of all the particles included in a certain area (an area including 100 or more particles).

Circularity=4πS/L² (1)

The average circularity is preferably as large as possible, and is preferably 0.60 or more, more preferably 0.70 or more, still more preferably 0.80 or more, particularly preferably 0.85 or more, and most preferably 0.90 or more. As a result, the rolling resistance of the particles when mixed with the base material is reduced, the viscosity of the base material is further reduced, and the fluidity of the base material can be further improved. In particular, when the average circularity is 0.90 or more, the fluidity of the base material is further increased, so that the base material can be further highly filled with the composite particles, and the thermal expansion coefficient can be easily reduced.

The diameter of the composite particle is not particularly limited, but may be 0.5 to 100 μm, or may be 1 to 50 μm, 1 to 40 μm, 1 to 30 μm, 1 to 20 μm, or 1 to 10 μm, considering that the powder is used as a filler blended in a base material. In the present specification, the diameter of the composite particle means a median diameter (D50) of the composite particles. The median diameter of the composite particles means 50% diameters (D50% diameters) in volume-based integrated fractions specified in JIS R 1629. In addition, the dispersion treatment before the measurement of the median diameter of the raw material particles and the addition of the dispersion liquid to the measurement apparatus are performed by the same method as described in “Median diameter of composite particles” in Examples.

The thermal expansion coefficient of the powder is preferably as small as possible, and is preferably 2×10⁻⁶/° C. or less, more preferably 1×10⁻⁶/° C. or less, and still more preferably 0.5×10⁻⁶/° C. or less, from the viewpoint of further reducing the thermal expansion coefficient of the base material in which the powder is blended. The thermal expansion coefficient can be measured by thermomechanical analysis (TMA).

A mixture can be obtained by using the above composite particle and a particle having a composition different from that of the above composite particle. That is, the mixture according to one embodiment contains a first particle composed of the above-described composite particle and a second particle different from the first particle. By mixing the above-mentioned composite particle and the second particle, it is possible to more easily adjust the thermal expansion coefficient, the thermal conductivity, the filling rate, and the like when the mixture is blended in the base material.

Examples of the second particle include particles of inorganic oxides such as SiO₂ and Al₂O₃. SiO₂ or Al₂O₃ having a higher purity is preferable. Since the thermal conductivity of SiO₂ is small, when SiO₂ is used as the second particle, the thermal expansion coefficient of the base material can be further reduced. When Al₂O₃ is used as the second particle, the thermal conductivity of the base material can be easily adjusted.

The shape of the second particle is preferably spherical. From the same viewpoint as the above-described composite particle (first particle), the average circularity of the second particle is preferably as large as possible, and is preferably 0.80 or more, more preferably 0.85 or more, and still more preferably 0.90 or more. The average circularity of the second particle is calculated by the same method as the average circularity of the composite particle described above (first particle).

In one embodiement, the diameter (median diameter (D₅₀)) of the second particles may be 0.01 μm or more, 0.05 μm or more, or 0.1 μm or more, and is preferably 3 μm or less, more preferably 2 μm or less, and still more preferably 1 μm or less. This can further reduce the viscosity of the base material containing the mixture. In one embodiment, from the same viewpoint, the diameter (median diameter (D₅₀)) of the second particles is preferably 10 μm or more, more preferably 20 μm or more, and even more preferably 30 μm or more, and may be 100 μm or less, 90 μm or less, or 80 μm or less. The median diameter of the second particles mean 50% diameter (D50% diameter) in volume-based integrated fractions specified in JIS R 1629.

The content of the second particles in the mixture is preferably 90% by volume or less, more preferably 70% by volume or less, still more preferably 50% by volume or less, particularly preferably 40% by volume or less, based on the total amount of the mixture. This makes it possible to more effectively reduce the thermal expansion coefficient of the base material. The content of the second particles may be 0.1% by volume or more, preferably 1% by volume or more.

The content of the first particles in the mixture is preferably 10% by volume or more, more preferably 30% by volume or more, still more preferably 50% by volume or more, particularly preferably 60% by volume or more, based on the total amount of the mixture, from the viewpoint of effectively reducing the thermal expansion coefficient of the base material. The content of the first particles in the mixture may be, for example, 99.9% by volume or less, preferably 99% by volume or less, based on the total amount of the mixture.

The total amount of the first particles and the second particles in the mixture may be 90% by volume or more, 92% by volume or more, or 95% by volume or more based on the total amount of the mixture. The mixture may consist of the first particles and the second particles.

The mixture may further contain additional particle having a different composition from the first particle and the second particle. When the second particle is an SiO₂ particle, the additional particle may be an Al₂O₃ particle. When the second particle is an Al₂O₃ particle, the additional particle may be an SiO₂ particle. The additonal particle may be, for example, a particle of at least one selected from the group consisting of zinc oxide, titanium oxide, magnesium oxide, and zirconium oxide. When the mixture contains the additional particle, the content of the additional particle may be, for example, 0.1 to 10% by volume based on the total amount of the mixture.

The composite particle or the mixture of the present embodiment may be used by being blended in a base material. The base material may be a glass in one embodiment. Examples of the glass include glasses having a composition of PbO-B₂O₃-ZnO type, PbO-B₂O₃-Bi₂O₃ type, PbO-V₂O₅-TeO₂ type, SiO₂-ZnO-M¹₂O (M¹₂O is an alkali metal oxide) type, SiO₂-B₂O₃-M¹₂O type, or SiO₂-B₂O₃-M²O type (M²O is an alkaline earth metal oxide).

The base material may be a resin in another embodiment. That is, one embodiment of the present invention may be a composition containing the composite particle described above and a resin, or may be a composition containing the first particle described above, the second particle described above, and a resin.

Examples of the resin include a epoxy resin, a silicone resin, a phenol resin, a melamine resin, an urea resin, an unsaturated polyester, a fluororesin, a polyamide (polyimide, polyamideimide, polyetherimide, etc.), a polybutylene terephthalate, a polyester (polyethylene terephthalate, etc.), a polyphenylene sulfide, a wholly aromatic polyester, a polysulfone, a liquid crystal polymer, a polyethersulfone, a polycarbonate, a maleimide-modified resin, an ABS (acrylonitrile-butadiene-styrene) resin, an AAS (acrylonitrile-acrylic rubber-styrene) resin, and an AES (acrylonitrile-ethylene-propylene-diene rubber-styrene) resin. The base material may be a mixture of these resins.

The blending amount (filling amount) of the composite particle or the mixture in the base material is appropriately selected according to physical properties such as a target thermal expansion coefficient. The blending amount of the composite particle or the mixture may be 30 to 95% by volume, preferably 40 to 90% by volume, based on the total amount of the base material after the addition of the powder.

When the mixture is blended in the base material, the first particles and the second particles may be mixed in the base material, or the first particles and the second particles may be mixed in advance and then blended in the base material.

By blending the composite particle or the mixture of the present embodiment into the base material, the viscosity of the base material after blending the composite particle or the mixture can be lowered. The base material in which the composite particle or the mixture of the present embodiment is blended has a low viscosity and thus has good fluidity and excellent moldability. When the composite particle or the mixture of the present embodiment is blended, the blending amount (filling rate) can be increased.

### EXAMPLES

Hereinafter, the present invention will be described in more detail with reference to examples, but the present invention is not limited to the examples.

### Example 1

(Production of Raw Material Particles)

ZnO, Al₂O₃, and SiO₂ were each used as raw materials, and these raw materials were mixed by a vibration mixer (manufactured by Resodyn, Lab RAM II). At this time, each raw material was mixed so that ZnO was 28% by mole, Al₂O₃ was 18% by mole, and SiO₂ was 54% by mole based on the total amount of these three components. 100 g of this mixture was placed in a platinum crucible and heated and melted in an electric furnace. At this time, the temperature in the electric furnace during melting was 1600° C., and the holding time at 1600° C. was 30 minutes. After melting, the crucible was immersed in water and quenched to obtain a raw material glass. The raw material glass was recovered from the platinum crucible and pulverized by a ball mill so as to have a median diameter of 10 μm or less to obtain a powder composed of raw material particles. The raw material particles had a median diameter (D50) of 5 μm.

(Spheroidizing Treatment)

The obtained raw material particles were charged into a high-temperature flame formed by LPG and oxygen gas by a carrier gas (oxygen), and spheroidized by a powder melting method. As a result, spheroidized raw material particles were obtained.

(Addition of Fine Particles)

0.1 parts by weight of SiO₂ fine particles (AEROSIL 130 manufactured by Nippon Aerosil Co., Ltd., specific surface: 130 m²/g, specific surface diameter: 21 nm) was added to 100 parts by mass of the spheroidized raw material particles.

(Crystallization)

The mixture of the spheroidized paricles and fine particles was pulverized, placed in an alumina crucible, and crystallized in an air atmosphere using an electric furnace at a furnace temperature of 800° C. for 1 hour at 800° C. Thus, composite particles according to Example 1 were obtained.

### Examples 2 to 5

Composite particles according to Examples 2 to 5 were obtained in the same manner as in Example 1 except that the amount of the SiO₂ fine particles added to 100 parts by mass of the raw material particles was changed to the amount described in Table 1.

### Examples 6 to 10

Composite particles according to Examples 6 to 10 were obtained in the same manner as in Example 1 except that the fine particles were changed from SiO₂ to Al₂O₃ fine particles (AEROXIDE-Alu-C manufactured by Nippon Aerosil Co., Ltd., specific surface: 100 m²/g, specific surface diameter: 18 nm), and the amount of the Al₂O₃ fine particles added to 100 parts by mass of the raw material particles was changed to the amount shown in Table 1.

### Example 11

A powder composed of the raw material particles was obtained in the same manner as in Example 1 except that ZnO, Al₂O₃, and SiO₂ were mixed so that ZnO was 22% by mole, Al₂O₃ was 18% by mole, and SiO₂ was 60% by mole based on the total amount of the three components. In addition, composite particles according to Example 11 were obtained in the same manner as in Example 1 except that the amount of the SiO₂ fine particles added to 100 parts by mass of the raw material particles was changed to the amount described in Table 1.

### Example 12

A powder composed of the raw material particles was obtained in the same manner as in Example 1 except that ZnO, Al₂O₃, and SiO₂ were mixed so that ZnO was 40% by mole, Al₂O₃ was 10% by mole, and SiO₂ was 50% by mole based on the total amount of the three components. In addition, composite particles according to Example 12 were obtained in the same manner as in Example 1 except that the amount of the SiO₂ fine particles added to 100 parts by mass of raw material particles was changed to the amount described in Table 1.

### Comparative Example 1

Particles according to Comparative Example 1 were obtained in the same manner as in Example 1 except that fine particles were not added to the raw material particles at all.

The properties of the produced composite particles or particles were evaluated by the following methods. The evaluation results are shown in Table 1.

### Identification of Crystalline Phase

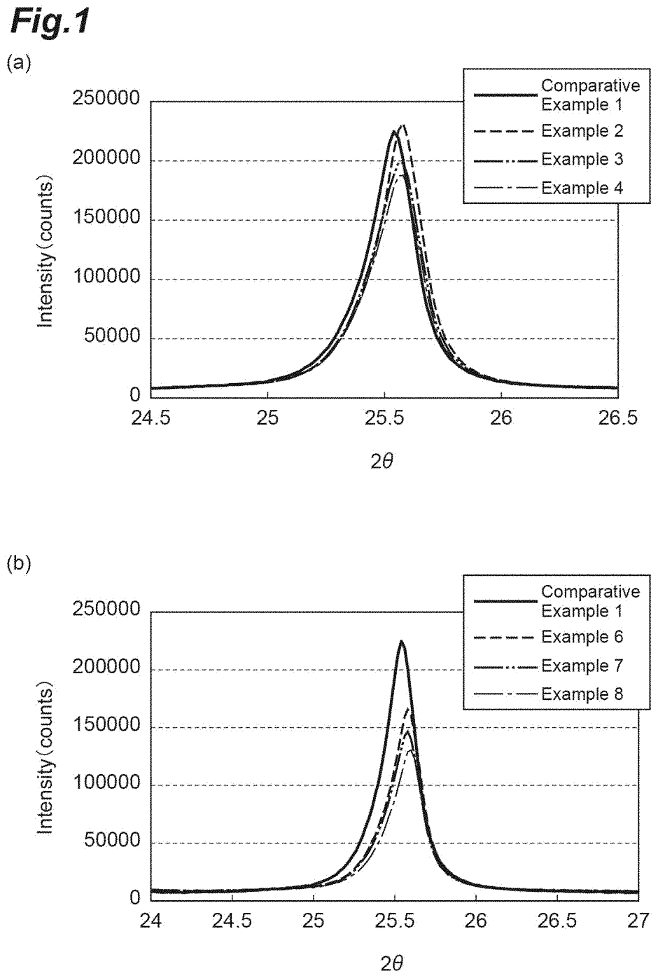

Identification of the crystalline phase contained in the composite particles or the particles after crystallization and determination of the content were performed by powder X-ray diffraction measurement/Rietveld method. A horizontal sample type multipurpose X-ray diffraction apparatus (RINT-UltimaIV, manufactured by Rigaku Corporation) was used as an apparatus, and the measurement was performed under the conditions of a CuK α X-ray source, a tube voltage of 40 kV, a tube current of 40 mA, a scan speed of 5.0 deg./min, and a 20 scan range of 10 deg. to 80 deg. The X-ray diffraction patterns (excerpts) of the composite particles of Examples 2 to 4 are shown in view (a) of FIG. 1, and the X-ray diffraction patterns (excerpts) of the composite particles of Examples 6 to 8 are shown in view (b) of FIG. 1. For comparison, X-ray diffraction patterns (excerpts) of the particles of Comparative Example 1 are shown in view (a) of FIG. 1 and view (b) of FIG. 1. For the quantitative analysis of the crystalline phase, Rietveld method software (integrated powder X-ray software Jade+9.6, manufactured by MDI) was used. The content b (% by mass) of the β-quartz solid solution phase was calculated by the following formula (2) using the ratio a (% by mass) of the β-quartz solid solution obtained by Rietveld analysis by X-ray diffraction measurement of a sample obtained by adding 50% by mass (based on the total amount of the sample after addition) of α-alumina (internal standard substance), which is a standard sample for X-ray diffraction manufactured by NIST, to the crystallized powder. The crystal structure of the β-quartz solid solution of the obtained particles was subjected to Rietveld analysis as Znₓ/2AlₓSi₃-ₓO₆ (x=1) with reference to the conventional technique (for example, Journal of Non-Crystalline Solids 351 149 (2005)). The quantitative analysis of the crystalline phase was performed for all Examples and Comparative Examples. The results are shown in Table 1.

b=100a/(100−a) (2)

### Analysis of ZnO, Al₂O₃ and SiO₂, and Quantification of Impurities

The analysis of ZnO, Al₂O₃ and SiO₂ (content analysis) and the quantification of impurities were performed by inductively coupled plasma emission spectroscopy. An ICP emission spectrometer (CIROS-120, manufactured by SPECTRO) was used as an analyzer. In the analysis of ZnO, Al₂O₃, SiO₂, 0.01 g of the composite particles was weighed in a platinum crucible, melted with a flux obtained by mixing potassium carbonate, sodium carbonate, and boric acid, and then dissolved by adding hydrochloric acid to prepare a measurement solution. In the analysis of impurities, 0.1 g of the composite particles was weighed in a platinum crucible and subjected to pressure acid decomposition at 200° C. using hydrofluoric acid and sulfuric acid to prepare a measurement solution.

### Average Circularity

The powder composed of composite particles was fixed to a sample stage with a carbon tape, coated with osmium, and photographed with a scanning electron microscope (JSM-7001F SHL, manufactured by JEOL Ltd.) at a magnification of 500 to 5000 times and the number of pixels of 2048×1356. The particles subjected to image analysis are in the range of 1 μm to 10 μm. Using an image analyzer (Image-Pro Premier Ver. 9.3, manufactured by Nippon Roper Co., Ltd.), the projected area (S) of the composite particles and the projected peripheral length (L) of the composite particles were calculated, and then the circularity was calculated from the following formula (1). The circularity of all particles in an observation region having an area in which 100 or more particles were contained was determined, and the average value thereof was defined as the average circularity.

Circularity=4πS/L² (1)

### Median Diameter of Composite Particles

The median diameter was measured using a laser diffraction particle size distribution analyzer (Beckman Coulter, LS 13 320). 50cm³ of pure water and 0.1 g of the obtained composite particles were placed in a glass beaker, and a dispersion treatment was performed for 1 minute using an ultrasonic homogenizer (SFX 250, manufactured by BRANSON). The dispersion liquid of the composite particles subjected to the dispersion treatment was added dropwise to a laser diffraction particle size distribution measuring apparatus with a dropper, and measurement was performed 30 seconds after a predetermined amount of the dispersion liquid was added. The particle size distribution was calculated from the data of the light intensity distribution of the diffracted/scattered light by the particles detected by the sensor in the laser diffraction particle size distribution measuring apparatus. The median diameter of the composite particles was calculated as 50% diameters (D50% diameters) in volume-based integrated fractions specified in JIS R 1629.

### Shape Observation of Composite Particle

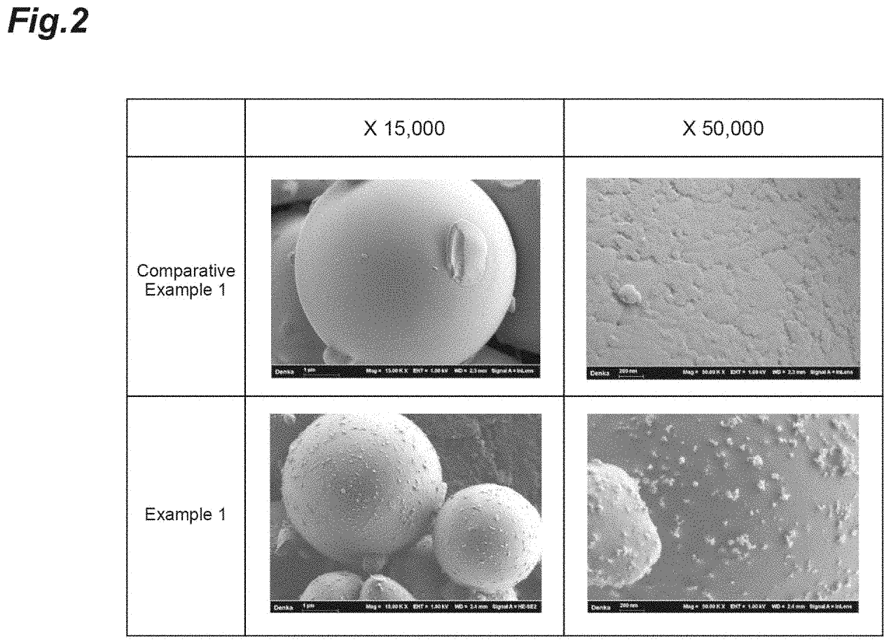

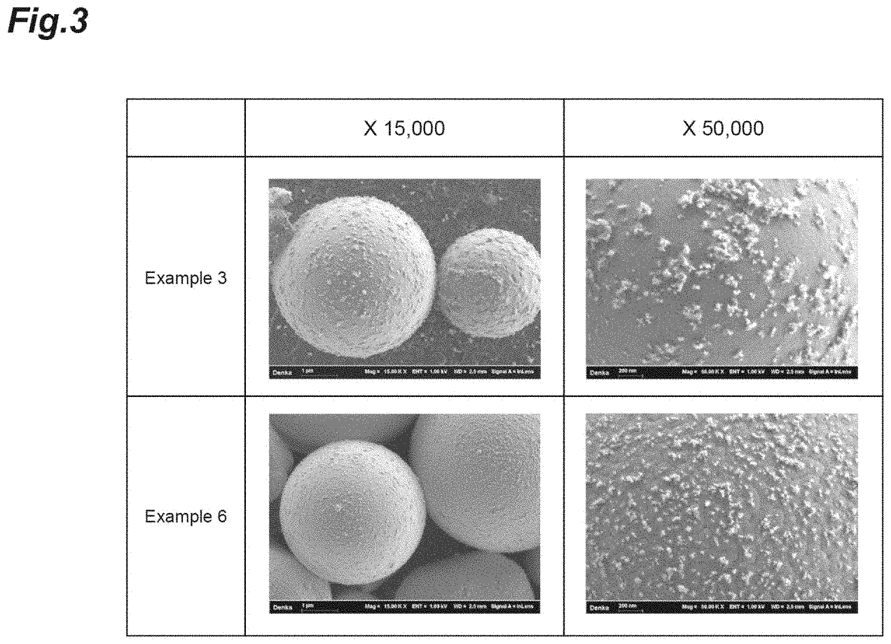

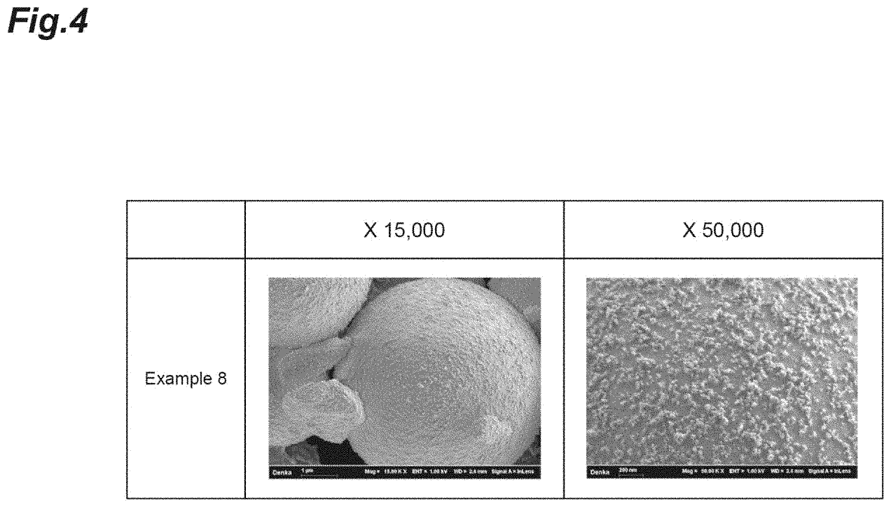

Each composite particle or particle of Examples 1, 3, 6 and 8 and Comparative Example 1 was observed using a scanning electron microscope (SEM). The observation results are shown in FIGS. 2 to 4. As shown in FIGS. 2 to 4, it was observed that the fine particles were fused to the surface of the core particle of the composite particles of Examples 1, 3, 6 and 8 in which the fine particles were added. On the other hand, fusion of fine particles was not observed about the particles of Comparative Example 1 in which no fine particles were added.

### Viscosity

A bisphenol A-type liquid epoxy resin (JER 828, manufactured by Mitsubishi Chemical Corporation) was mixed such that the composite particles were 50% by volume of the whole, and the mixture was kneaded with a planetary stirrer (“Awatori Rentaro AR-250”, manufactured by Thinky Corporation, rotation speed : 2000 rpm) to prepare a resin composition. The viscosity of the obtained resin composition was measured under the following conditions using a rheometer (MCR 300, manufactured by Nihon Sibermheguna Co., Ltd.). The relative value of the viscosity (relative viscosity) of the resin composition using the composite particles of each Example was calculated by setting the viscosity of the resin composition using the particle of Comparative Example 1 to 100.

Plate shape : circular flat plate 25 mmϕ
Sample thickness : 1 mm

### Temperature : 25±1° C.

Shear rate : 1 s⁻¹

TABLE 1

| | | | Example | | | | |
|---|---|---|---|---|---|---|---|
| | | | 1 | 2 | 3 | 4 | 5 |
| Fine | Type | | SiO₂ | | | | |
| particles | Addition amount | | 0.1 | 0.2 | 0.5 | 1.0 | 2.0 |
| | (parts by mass/100 parts | | | | | | |
| | by mas of raw material | | | | | | |
| | particles) | | | | | | |
| Properties | Composition of | ZnO | 28 | 28 | 28 | 28 | 27 |
| of | composite | Al₂O₃ | 18 | 18 | 18 | 18 | 18 |
| composite | particle (after | SiO₂ | 54 | 54 | 54 | 54 | 55 |
| particles | crystallization) | | | | | | |
| | Amount of | Li | 11 | 16 | 10 | 15 | 19 |
| | impurities | Na | 52 | 62 | 45 | 68 | 61 |
| | (ppm by mass) | K | 18 | 19 | 27 | 29 | 32 |

| | | | | | |
|---|---|---|---|---|---|
| Content of β-quartz | 85 | 85 | 85 | 75 | 70 |
| solid solution phase | | | | | |
| (% by mass) | | | | | |
| Median diameter (μm) | 5 | 5 | 4 | 3 | 4 |
| Average circularity | 0.92 | 0.95 | 0.96 | 0.93 | 0.93 |

| | | | | | |
|---|---|---|---|---|---|
| Viscosity (relative viscosity) of | 85 | 80 | 75 | 70 | 85 |
| resin composition | | | | | |

| | | | Example | | | | |
|---|---|---|---|---|---|---|---|
| | | | 6 | 7 | 8 | 9 | 10 |
| Fine | Type | | Al₂O₃ | | | | |
| particles | Addition amount | | 0.1 | 0.2 | 0.5 | 1.0 | 2.0 |
| | (parts by mass/100 parts | | | | | | |
| | by mas of raw material | | | | | | |
| | particles) | | | | | | |
| Properties | Composition of | ZnO | 28 | 28 | 28 | 28 | 27 |
| of | composite | | | | | | |
| composite | particle (after | Al₂O₃ | 18 | 18 | 19 | 19 | 20 |
| particles | crystallization) | SiO₂ | 54 | 54 | 53 | 53 | 53 |
| | Amount of | Li | 21 | 18 | 16 | 29 | 5 |
| | impurities | Na | 59 | 52 | 49 | 65 | 61 |
| | (ppm by mass) | K | 29 | 32 | 41 | 25 | 36 |

| | | | | | |
|---|---|---|---|---|---|
| Content of β-quartz solid | 65 | 55 | 50 | 45 | 40 |
| solution phase | | | | | |
| (% by mass) | | | | | |
| Median diameter (μm) | 5 | 5 | 5 | 4 | 5 |
| Average circularity | 0.92 | 0.95 | 0.95 | 0.95 | 0.93 |

| | | | | | |
|---|---|---|---|---|---|
| Viscosity (relative viscosity) of | 80 | 75 | 70 | 65 | 80 |
| resin composition | | | | | |

| | | | | | Comparative |
|---|---|---|---|---|---|
| | | | Example | | Example |
| | | | 11 | 12 | 1 |
| Fine | Type | | SiO₂ | | — |
| particles | Addition amount | | 1.0 | 1.0 | — |
| | (parts by mass/100 parts | | | | |
| | by mas of raw material | | | | |
| | particles) | | | | |
| Properties | Composition of | ZnO | 22 | 39 | 28 |
| of | composite | Al₂O₃ | 18 | 11 | 18 |
| composite | particle (after | SiO₂ | 60 | 50 | 54 |
| particles | crystallization) | | | | |
| | Amount of | Li | 9 | 10 | 9 |
| | impurities | Na | 67 | 71 | 70 |
| | (ppm by mass) | K | 28 | 24 | 32 |

| | | | |
|---|---|---|---|
| Content of β-quartz solid | 75 | 75 | 85 |
| solution phase | | | |
| (% by mass) | | | |
| Median diameter (μm) | 5 | 5 | 5 |
| Average circularity | 0.96 | 0.95 | 0.90 |

| | | | |
|---|---|---|---|
| Viscosity (relative viscosity) of | 70 | 70 | 100 |
| resin composition | | | |

### Industrial Applicability

The composite particles obtained by the production method according to the present invention can be used as a filler capable of reducing the thermal expansion coefficient of a base material when the powder or the mixture is filled in the base material such as a glass or a resin. In addition, the base material containing the composite particles of the present invention has low viscosity and high fluidity, and thus can be used as a filler that can be highly filled.

1. A method for producing a composite particle, the method comprising:
(a) mixing a raw material particle and at least one type of fine particles selected from SiO₂ fine particles and Al₂O₃ fine particles, the fine paricles having a diameter smaller than that of the raw material particle; and
(b) heating the mixture of the raw material particles and the fine particles,
wherein the raw material particle comprises three components of ZnO, Al₂O₃, and SiO₂, and a content of the ZnO is 17 to 43% by mole, a content of the Al₂O₃ is 9 to 20% by mole, and a content of the SiO₂ is 48 to 63% by mole, based on the total content of the three components.

2. The method according to claim 1, wherein the fine particles are added in an amount of 4 parts by mass or less based on 100 parts by mass of the raw material particle in the (a).

3. A composite particle comprising:
a core particle comprising three components of ZnO, Al₂O₃, and SiO₂; and
at least one type of fine particles selected from SiO₂ fine particles and Al₂O₃ fine particles, the fine particles having a diameter smaller than that of the core particle and being fused to the surfaces of the core particle,
wherein a content of the ZnO is 17 to 43% by mole, a content of the Al₂O₃ is 9 to 20% by mole, and a content of the SiO₂ is 48 to 63% by mole, based on the total content of the three components, in the core particle.

4. The composite particle according to claim 3, wherein the composite particle has an average circularity is 0.60 or more.

5. The composite particle according to claim 3, wherein the composite particle comprises 50 mass % or more of a β-quartz solid solution as a crystal phase based on the total amount of the composite particle.

6. The composite particle according to claim 3, wherein a content of each of Li, Na, and K is less than 100 ppm by mass based on the total amount of the composite particle.

7. The composite particle according to claim 3, wherein the composite particle is used by being blended in a glass or a resin.

8. A mixture comprising:
a first particle that is the composite particle according to claim 3; and
a second particle different from the first particle.

9. The mixture according to claim 8, wherein the second particle has an average circularity of 0.80 or more.

10. The mixture according to claim 8, wherein a content of the first particle is 10 vol % or more based on the total amount of the mixture.

11. The mixture according to claim 8, wherein the second particle is an SiO₂ particle or an Al₂O₃ particle.

12. The mixture according to claim 8, wherein the mixture is used by being blended in a glass or a resin.
